(19) United States
(12) Patent Application Publication
(10) Pub. No.: US 2026/0027588 A1
(43) Pub. Date: Jan. 29, 2026

(54) Screening machine

(71) Applicant: Kleemann GmbH, Göppingen (DE)

(72) Inventor: Florian Nägele, Hüttisheim (DE)

(21) Appl. No.: 19/238,647

(22) Filed: Jun. 16, 2025

(30) Foreign Application Priority Data
Jul. 23, 2024 (DE) 10 2024 120 878.3

(51) Int. Cl. B07B 1/28; B07B 1/00; F16F 15/02

(52) U.S. Cl. CPC B07B 1/28; F16F 15/022; B07B 1/005

(57) ABSTRACT

A screening machine includes a chassis, to which a screen tray is fastened, wherein at least one screen lining is replaceably fastened to the screen support, wherein at least one vibration damper is effective between the screen tray and the machine chassis. The vibration damper includes two coupling pieces. One coupling piece is connected directly or indirectly to the machine chassis and the other coupling piece is connected directly or indirectly to the screen support. A damping lever is swivel connected to each of the two coupling pieces. The damping levers are each coupled to a damping body facing away from the coupling pieces. One gap area each is formed in the spacer area between the coupling pieces and the damping body, and at least one of the gap areas is bridged at least sectionally by a filler piece connected to the coupling piece or the damping element.

### RELATED APPLICATION

The present application claims priority to German Patent Application Ser. No. DE 10 2024 120 898.3, filed Jul. 23, 2024, which is incorporated herein by reference.

### BACKGROUND OF THE DISCLOSURE

### Field of the Disclosure

The disclosure relates to a screening machine for screening and sizing mineral lump material, in particular rock material, or recycling material, having a chassis, to which a screen support, in particular a screen tray, is fastened, wherein at least one screen lining is replaceably fastened to the screen support, and wherein at least one vibration damper is effective between the screen tray and the machine chassis.

Description of the Prior Art

EP 0 238 455 A2 discloses a screening machine having a screen tray, in which a screen lining is disposed. The screen tray is supported against the chassis of the screening machine by means of vibration dampers in the form of springs. The screen tray can be vibrated by means of a drive.

There is a risk of injury with such screening machines, as a user can access the vibration dampers during machine operation and get their hand trapped. It would be possible to shield the vibration dampers by means of an enclosure to prevent access. However, this has the disadvantage that the vibration dampers can no longer be inspected visually during operation. In some cases, solutions are also known, in which curtains are hung in front of the vibration dampers to make unhindered access more difficult. Here too, the disadvantage is that continuous inspection is not guaranteed. If an inspection is performed, the curtain has to be lifted. The vibration damper can then be accessed again unhindered and there is again a risk of injury.

### SUMMARY OF THE DISCLOSURE

The disclosure addresses the problem of improving the operational safety of the screening machine described above.

This problem is solved by the features of the claims. Accordingly, provision is made for the vibration damper to have two coupling pieces, wherein one coupling piece is connected directly or indirectly to the machine chassis and the other coupling piece is connected directly or indirectly to the screen support, and for a damping lever to be swivel connected to each of the two coupling pieces, wherein the damping levers are each coupled to a damping body facing away from the coupling pieces, wherein a gap area each is formed in the spacer area between the coupling pieces and the damping body, and wherein at least one of the gap areas is bridged at least sectionally by means of at least one filler piece connected to the coupling piece or the damping element.

On the one hand, this arrangement makes for an effective damping of the vibration motions. The oscillation motions are damped by the damped damping levers. To prevent a user from being injured on the vibration damper, the gap area between the coupling piece and the damping body is bridged by the filler piece. In this way, the user can no longer reach into this danger zone and trap his hand there. A vibration damper of this type can therefore be integrated into the machine structure such that it is visible from the outside and safe to work with, permitting a continuous inspection. Depending on the structural conditions, filler pieces can of course also be disposed in both gap areas.

According to a preferred variant of the disclosure, provision may be made for the filler piece to have a base body, for the base body to have a mounting surface, and for the base body to be fastened, in particular fastened using a material bond, by means of the mounting surface on a lateral surface of the coupling piece facing the damping body or on a lateral surface of the damping body facing the coupling piece. Machine superstructures, in which vibration dampers are inaccessible or difficult to access, are conceivable. They can then be operated without a filler piece. The damping elements, which are accessible from the outside, can optionally be fitted with a filler piece. This reduces the cost and effort in parts and assembly in addition to storage costs.

For a precise positioning of the filler piece, provision may be made for the mounting surface of the filler piece to merge into a concave form-fitting surface, which at least sectionally encompasses a convex rounded section adjoining the lateral surface of the coupling element or of the damping element. In this way, the positional stability of the filler piece is additionally improved.

A preferred variant of the invention can be such that the filler piece has a convex protection surface, which faces the damping body or the coupling piece. During the damping process, the damping lever is swiveled about a swivel axis. The protection surface is circumnavigated by the contour of the damping body or coupling piece opposite in the gap area. The convex protection surface can thus be shaped to suit these motion kinematics to prevent the hand from becoming trapped in the various swivel positions of the damping lever.

According to the disclosure, provision may be made for the protection surface to extend essentially in the direction of the swivel axis of the damping lever to bridge the gap area in the depth direction.

According to a variant of the disclosure, provision may be made for a front surface to be disposed in front of the protection surface in the damping direction of the damping lever, which front surface extends essentially in the direction of the swivel axis of the damping lever and which front surface is merged into the protection surface by means of a rounded transition or a bevel. The front surface protects access to the gap area from the front. Additionally or alternatively, provision may also be made for a rear surface to be disposed behind the protection surface in the damping direction of the damping lever, which rear surface extends essentially in the direction of the swivel axis of the damping lever and which rear surface is merged into the protection surface by means of a rounded transition. In this way, access to the gap area from the rear is prevented.

According to the disclosure, the filler piece can be used to bridge the gap area without leaving a gap. However, preferably provision is made for a spacer area to be formed between the protection surface and an opposite lateral surface of the damping body or of the coupling piece, wherein preferably provision is made for the spacer area to be retained at a constant or variable distance across a substantial part of the swivel motion of the damping lever or for the spacer area to be retained at a constant or variable distance across the entire swivel motion of the damping lever. In this way, the wear acting on the support surface and thus on the filler piece is minimized. The spacer area can be dimensioned such that there is no risk of a finger entering the spacer area.

The vibration damper offers a reliable function based on a simple design if provision is made for at least one of the coupling pieces to have a hollow body, in which a rotary body is disposed in a swiveling manner, for the rotary body to bear or have a bearing piece, which accommodates the damping lever, and for damping elements to be inserted into the hollow body, which damping elements support the hollow body in a form-fitting manner relative to the rotary body in the circumferential direction.

A design variant of the vibration damper is also conceivable, in which provision is made for the damping body to have a frame, which has two hollow chambers, for a rotary body to be disposed in a swiveling manner in each hollow chamber, for the rotary bodies to each bear or have a bearing piece, for a damping lever to be attached to each of the bearing pieces and for damping elements to be inserted in the hollow chambers, which support the frame in a form-fitting manner relative to the rotary bodies in the circumferential direction.

### BRIEF DESCRIPTION OF THE DRAWINGS:

The disclosure is explained in greater detail below based on exemplary embodiments shown in the drawings. In the figures,

FIG. 1 shows a side view of a screening machine,

FIG. 2 shows a schematic diagram of a screen deck of the screening machine of FIG. 1,

FIG. 3 shows a partial perspective view of a tensioning device for a screen lining of the screening machine of FIG. 1,

FIG. 4 shows an enlarged detailed view of a screen tray of the screening machine of FIG. 1 in a first assembly position,

FIG. 5 shows the illustration of FIG. 1 with a mounted vibration damper,

FIG. 6 shows the vibration damper of FIG. 5 in an enlarged individual view and in side view,

FIG. 7 shows a perspective front view of the vibration damper of FIG. 6 and

FIG. 8 shows a perspective view from the rear of the vibration damper of FIGS. 6 and 7.

### DETAILED DESCRIPTION

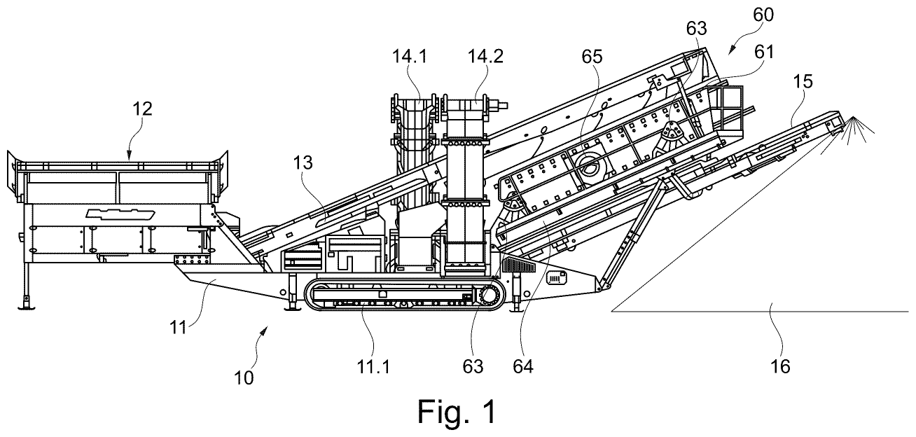

FIG. 1 shows a screening machine 10 according to the disclosure. This screening machine 10 is designed as a mobile screening machine 10. It is also conceivable that the disclosure could be used in a stationary screening machine. It is also conceivable that a screening plant having a screening machine 10 could be used in a combined crushing and screening plant. Such a combined crushing and screening plant has a chassis 11, on which a screening machine 10 and also a crusher unit are mounted. The crusher unit can be used to crush mineral material. The shredded material is then sized in the screening machine.

The screening machine 10 shown in FIG. 1 has a chassis 11, which is supported by undercarriages 11.1 to be able to move the screening machine 10. Preferably, the screening machine 10 has a feed hopper 12. A wheel loader can be used to fill material to be screened into the feed hopper 12.

The feed hopper 12 has a transport device, for instance a vibrating chute, a conveyor belt, a feed belt or a bunker discharging conveyor, by means of which the fed material can be conveyed to an infeed belt 13. The infeed belt 13 can be designed as an endless circulating conveyor belt. The infeed belt 13 conveys the material to be screened to a screen device, which has a screen tray 60.

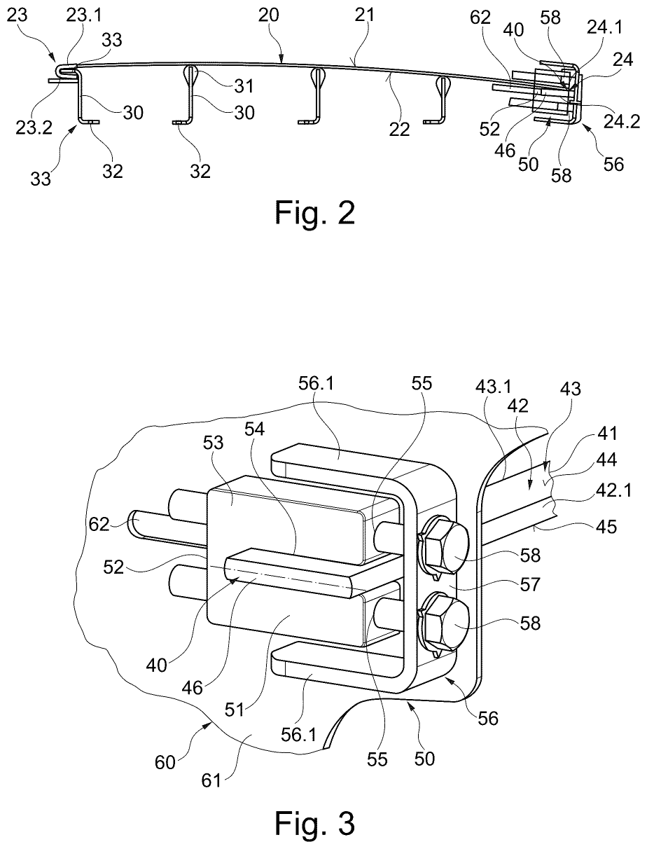

The screen device is used to screen out at least two fractions from the material fed in. For this purpose, the screen device has at least one screen lining 20, as shown in FIG. 2.

FIG. 1 further illustrates that the screen tray 60 has end walls 61, which extend in the longitudinal direction of the screen.

The screen tray 60 can be mounted on a stationary screen tray support 64 by means of spring elements 63. A drive 65 can be used to oscillate the screen tray 60 to screen the material.

At least one discharge belt 14.1, 14.2 or at least one fine grain or stockpile belt 15 is assigned to the screen device. In this exemplary embodiment, two discharge belts 14.1, 14.2 and a fine-grain or stockpile belt 15 are used. Accordingly, two screen linings 20 are installed in the screen device.

The material to be screened is fed onto the upper screen lining 20. The material that falls through the upper screen lining 20 reaches the screen lining 20 below. Material that does not fall through the upper screen lining 20 reaches one of the two discharge belts 14.1, 14.2. The material that does not fall through the second screen lining 20 reaches the second discharge belt 14.1, 14.2. The material, which falls through both screen linings 20 in the form of fine-grain material, reaches the fine-grain or stockpile belt 15. The two discharge belts 14.1, 14.2 and the fine grain or stockpile belt 15 convey the grain fractions fed thereto onto stockpiles 16.

FIG. 2 shows a schematic representation of a screen device. As the illustration shows, support elements 30 are installed in the screen tray 60 to support the screen lining 20. The support elements 30 have a mounting foot 32, which is used to mount them stationarily in the screen tray 60. Opposite from the mounting foot 32, damping elements 31 are mounted on one end of the support elements 30 in a replaceable manner. The damping elements 31 support the screen lining 20 in the area of the bottom of the screen 22.

The support elements 30 can be disposed and aligned with their damping elements 31 in such a way that the screen lining 20 resting on the damping elements 31 forms a curved contour in the longitudinal direction of the screen, as FIG. 2 shows.

The support element 30 on the left-hand side in FIG. 2 has a holder neck 33 at its end facing away from the mounting foot 32. The screen lining 20 is held replaceably on the holder neck 33 by a fastening edge 23.

The screen lining 20 is designed as a flat element and has a screen top 21 opposite from the screen bottom 22. The fastening edge 23 may be bent away from an end section 23.1 of the screen lining 20 to form a bend 23.2. The holding lug 33 engages with this bend 23.2.

At the end facing away from the fastening edge 23, the screen lining 20 has a further fastening edge 24, which can be of essentially the same design as the fastening edge 23. Accordingly, a bend 24.2 is bent away from the screen lining 20 at the opposite end section 24.1.

The screen lining 20 has to be tensioned in the screen tray 60 in the longitudinal direction (i.e. from left to right in FIG. 2). A screen tensioner 40 is used for this purpose. The screen clamp 40 is preferably essentially rectangular in cross-section. The screen tensioner 40 can therefore have a bar-shaped geometry.

The screen tensioner 40 has a central tensioning section 41, which extends between two end fastening sections 46.

The tensioning section 41 has tensioning projections 42, 43 on its opposite longitudinal ends. The first tensioning projection 42 has a first tensioning edge 42.1. The second tensioning projection 43 has a second tensioning edge 43.1.

The first tensioning edge 42.1 extends in a convexly curved manner between the two fastening sections 46.

In the exemplary embodiment shown, the screen tensioner 40 engages with its first tensioning projection 42 in the right-hand bend 24.2 shown in FIG. 2. The first tensioning edge 42.1 of the screen tensioner 40 is in contact with the base section 42.3 below the bottom of the screen 22, which base section results from the bend 24.2. The tensioning projection 42 is thus at least partially enclosed between the bottom of the screen 22 and the bend 24.2.

The fastening sections 46 of the screen tensioner 40 penetrate feedthroughs 62 in the assigned end walls 61 of the screen tray 60 on opposite ends, as FIG. 3 clearly shows. Accordingly, the fastening sections 46 protrude on the outside beyond the end walls 61 of the screen tray 60. Tensioning devices 50, which can be used to adjust the screen tensioner 40 in the tensioning direction along its central transverse plane are disposed in the area of the feedthroughs 62 of the screen tray 60.

The tensioning devices 50 each have a stationary support bearing 56, which is preferably firmly connected, for instance welded, to the lateral casing 61.

The support bearing 56 can be designed such that it has a holder 57 to which at least one bearing piece 56.1 is connected, preferably integrally formed. By means of the two bearing pieces 56.1 and the holder 57, the support bearing 56 can be firmly connected to the assigned lateral casing 61. The tensioning device 50 also has a tensioning piece 52, which engages behind the screen tensioner 40 in a form-fitting manner to move it in the tensioning direction. Legs 51, 53 may be connected, preferably molded, to the tensioning piece 52 on opposite ends.

Between the legs 51, 53 there is a mount 54 for the screen tensioner 40. The leg 53 overlaps the top 44 and the leg 51 overlaps the bottom 45 of the screen tensioner 40 such that the screen tensioner 40 is prevented from moving in these directions when it is tensioned.

At least one tensioning bolt 58 is used to adjust the tensioning piece 52 in the tensioning direction, by means of which tensioning bolt the tensioning piece 52 can be continuously adjusted. In so doing, the tensioning bolt 58 rests against the holder 57. The tensioning piece 52 can be continuously adjusted via a threaded connection.

In this exemplary embodiment, each of the legs 51, 53 has a threaded mount 55. The holder 57 has two feedthroughs through which the tensioning bolts 58 are inserted and screwed into the threaded mounts 55.

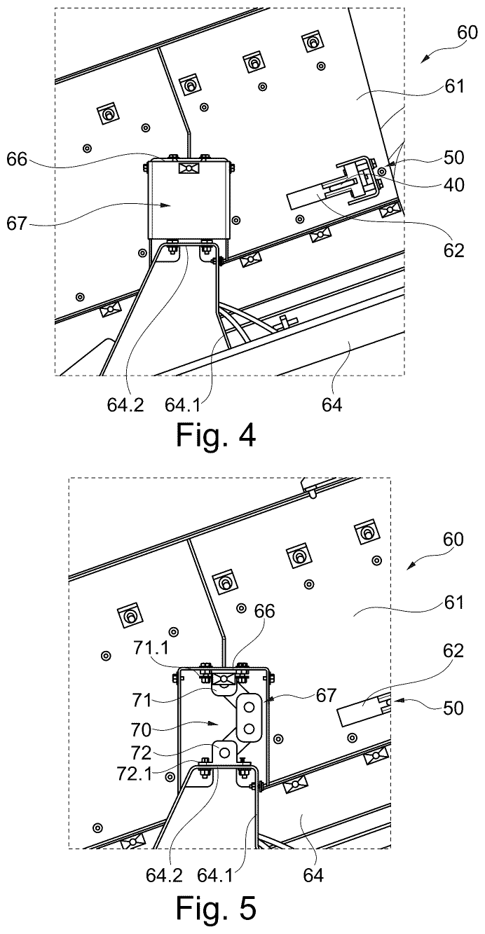

FIG. 4 illustrates that the screen tray support 64 has at least one holder 64.1. Preferably, holders 64.1 are disposed on opposite ends of the screen tray 60.

The holders 64.1 have a fastening section 64.2, which is disposed in the area 67 of the lateral casing 61 of the screen tray 60.

Opposite from the fastening section 64.2 of the screen tray support 64, the screen tray 60 has a support section 66. During operation, the vibration motions cause the screen tray 60 to move relative to the screen tray support 64, such that the support section 66 also moves relative to the fastening section 64.2.

FIG. 5 illustrates that a vibration damper 70 is installed between the fastening section 64.2 and the support section 66. The vibration damper 70 is disposed in the area 67 of the lateral casing 61.

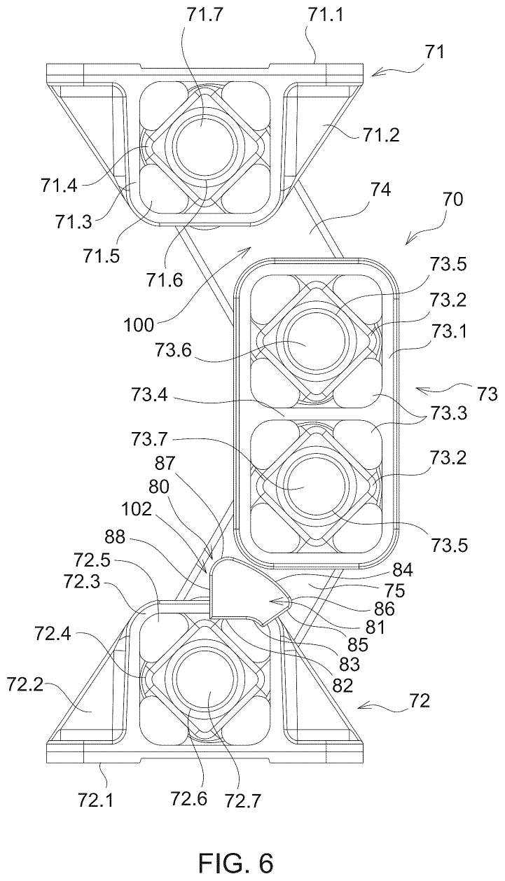

FIG. 6 illustrates the structure of the vibration damper 70. As this illustration shows, the vibration damper 70 has two coupling pieces 71, 72. The coupling pieces 71 and 72 may be referred to as first and second coupling pieces 71 and 72, respectively.

The coupling piece 71 connects the vibration damper 70 to the support section 66 of the screen tray 60. The coupling piece 72 connects the vibration damper 70 to the fastening section 64.2 of the holder 64.1.

A damping mechanism having a damping body 73 is effective between the two coupling pieces 71, 72, which damping body damps the vibrations of the screen tray 60.

The coupling piece 71, 72 has a mounting flange 71.1, 72.1. The mounting flange 71.1, 71.2 can be used to connect the coupling piece 71, 72 to the support section 66 or the fastening section 64.2.

The coupling piece 71, 72 may have a hollow body 71.3, 72.3. The hollow body 71.3, 72.3 encompasses a cavity. A rotary body 71.4, 72.4 is disposed in the cavity of the hollow body 71.3, 72.3, which rotary body can be formed, for instance, by a polygonal hollow section, such as a rectangular hollow section, as shown in FIG. 6. Damping elements 71.5, 72.5 are inserted into the hollow body 71.3, 72.3 laterally of the rotary body 71.4. The damping elements 71.5, 72.5 are used to damp the rotary motion of the rotary body 71.4, 72.4 in relation to the hollow body 71.3, 72.3. In this way, a rotary motion of the rotary body 71.4, 72.4 is damped and the damping elements 71.5, 72.5 simultaneously generate a restoring force to return the rotary body 71.4, 72.4 to a neutral position after it has been deflected.

The rotary body 71.4, 72.4 has a bearing piece 71.6, 72.6. Bearing pieces 71.7, 72.7 can be used to mount damping levers 74, 75 on bearing pieces 71.6, 72.6 for co-rotation. The damping levers 74 and 75 may be referred to as first and second damping levers 74 and 75, respectively.

Preferably, the two coupling pieces 71, 72 are of identical design, as shown in the drawings.

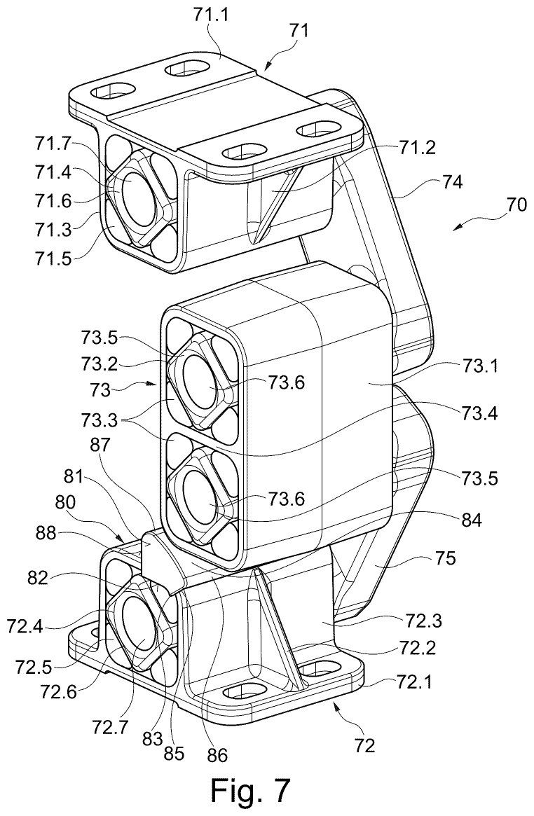

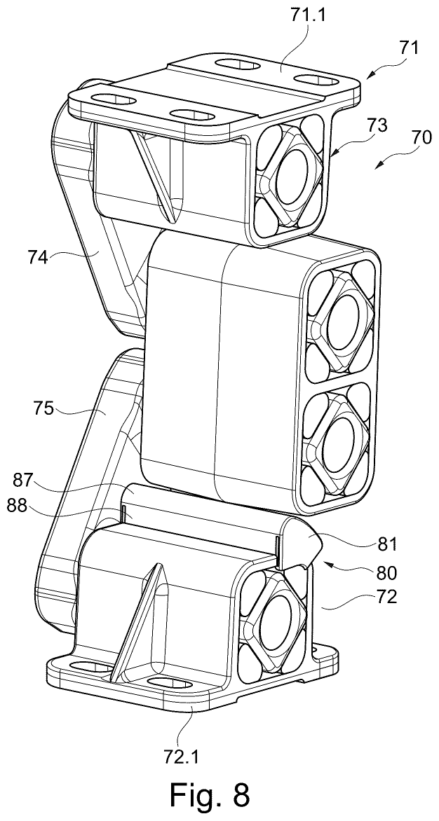

To improve the rigidity of the coupling pieces 71, 72, provision may be made for reinforcing elements 71.2, 72.2 to laterally support the hollow body 71.3, 72.3 relative to the mounting flange 71.1, 72.1. The reinforcing elements 71.2, 72.2 can take the shape of stiffening ribs, as shown more clearly in FIG. 7 or FIG. 8.

FIG. 6 further illustrates that the vibration damper 70 has a frame 73.1, which forms two hollow chambers. Rotary bodies 73.2 are disposed in the hollow chambers. Similar to the coupling pieces 71, 72, the rotary bodies 73.2 are again supported in the circumferential direction relative to the frame 73.1 by means of damping elements 73.3. In this way, the rotary motion of the rotary bodies 73.2 or the return of the rotary bodies 73.2 to the neutral position as shown in FIG. 6 can be achieved.

As the illustrations show, the frame 73.1 can be designed as a hollow section that forms the two hollow chambers. The hollow chambers can be separated from each other by means of a separating strip 73.4.

Again, the rotary bodies 73.2 can have bearing pieces 73.5. A bearing element 73.7 is used to mount the two damping levers 74, 75 on the bearing pieces 73.5 for co-rotation.

If the screen tray 60 is now vibrated during operation, the vertical distance between the support section 66 and the fastening section 64.2 varies. This causes the coupling pieces 71, 72 to be moved relative to each other in a vertical direction. This adjustment causes the damping levers 74, 75 to swivel. The damping elements 71.5, 72.5 and 73.3 are used to damp the swivel motion.

Gap areas 100 and 102 are formed in the spacer area between the outer contour of the coupling pieces 71, 72 and the outer contour of the damping body 73. At least one of the gap areas is at least sectionally bridged by means of a filler piece 80 connected to the coupling piece 71, 72 or the damping element 73. FIGS. 6-8 show only one filler piece 80. However, filler pieces can of course also be provided in both gap areas.

The filler pieces 80 are used to prevent a user from accessing the gap area between the coupling piece 71, 72 and the damping body 73. In this way, users are prevented from having their fingers trapped in this gap area.

As the illustrations show, the filler piece 80 has a base body 81. This base body 81 forms a mounting surface 82. This mounting surface 82 of the base body 61 is placed on an outer surface of the coupling piece 71, 72 or of the damping body 73.

Preferably, the filler piece 80 is connected to the coupling piece or the damping body 73 by means of a material bond in the area of the mounting surface 82.

The mounting surface 82 may merge into an angled or concave positive locking surface 83. This positive locking surface 83 encompasses a matching body edge of the coupling piece 71, 72 or of the damping body 70. In this way, the filler piece 80 can be aligned precisely. In addition, the form-fitting surface 83 additionally secures the position of the filler piece 80 in a form-fitting manner in the direction of motion of the damping levers 74, 75 during operation.

As the drawings show, the filler piece 80 has an outer protection surface 84, which faces the damping body 73 or the coupling piece 71, 72, forming a gap. The gap is dimensioned such that a user cannot reach into it, preventing fingers from being trapped.

Preferably, the protection surface 84 is at least sectionally convex. The geometry of the protection surface 84 is designed for the motion kinematics of the damping body 73. In this way, a gap area can be retained across the entire range of motion of the damping body 73, which gap area prevents a finger from becoming trapped.

At the front end, the protection surface 84 merges into a front surface 85 via a rounded transition 86. Conversely, the supporting surface 84 merges into a rear surface 88 via a rounded transition 87, as shown in FIG. 6 in particular.

1-11. (canceled)

12. A screening machine for screening and sizing mineral lump material, comprising:
a machine chassis;
a screen support;
a screen lining supported by the screen support; and
at least one vibration damper arranged between the screen support and the machine chassis, the at least one vibration damper including:
a first coupling piece connected directly or indirectly to the machine chassis;
a second coupling piece connected directly or indirectly to the screen support;
a damping body spaced from the first coupling piece by a first gap area and spaced from the second coupling piece by a second gap area;
a first damping lever swivel connected to the first coupling piece and swivel connected to the damping body;
a second damping lever swivel connected to the second coupling piece and swivel connected to the damping body; and
at least one filler piece at least partially bridging at least one of the gap areas, the at least one filler piece being connected to at least one of the coupling pieces or to the damping body.

13. The screening machine of claim 12, wherein:
the at least one filler piece includes a base body, the base body including a mounting surface, wherein the mounting surface of the base body is fastened on a lateral surface of one of the coupling pieces facing the damping body or on a lateral surface of the damping body facing one of the coupling pieces.

14. The screening machine of claim 13, wherein:
the mounting surface of the base body is fastened on the lateral surface of the one of the coupling pieces or on the lateral surface of the damping body by a material bond.

15. The screening machine of claim 13, wherein:
the mounting surface of the base body merges into a concave form-fitting surface of the base body, and the concave form-fitting surface of the base body at least partially encompasses a convex rounded section adjoining the lateral surface of the coupling piece or the lateral surface of the damping body.

16. The screening machine of claim 12, wherein:
the at least one filler piece includes a convex protection surface facing the damping body or facing one of the coupling pieces.

17. The screening machine of claim 16, wherein:
the convex protection surface extends in a direction of a swivel axis of a swivel connection between the damping body and one of the damping levers.

18. The screening machine of claim 16, wherein:
the at least one filler piece further includes a front surface disposed in front of the protection surface, the front surface extending in a direction of a swivel axis of a swivel connection between the damping body and one of the damping levers, and the front surface merging into the protection surface by a rounded transition.

19. The screening machine of claim 18, wherein:
the at least one filler piece further includes a rear surface disposed behind the protection surface, the rear surface extending in the direction of the swivel axis, and the rear surface merging into the protection surface by a further rounded transition.

20. The screening machine of claim 16, wherein:
the at least one filler piece and the damping body or the one of the coupling pieces are arranged such that a gap is formed between the protection surface and the damping body or the one of the coupling pieces.

21. The screening machine of claim 12, wherein:
at least one of the coupling pieces includes a hollow body;
a rotary body is disposed in the hollow body in a swiveling manner, the rotary body including a bearing piece connected to one of the damping levers; and
a plurality of damping elements are received in the hollow body to support the hollow body relative to the rotary body in a form-fitting manner in a circumferential direction.

22. The screening machine of claim 12, wherein:
the damping body includes a frame, the frame including two hollow chambers;
a rotary body is disposed in each hollow chamber in a swiveling manner, the rotary bodies each including a bearing piece connected to a respective one of the damping levers; and
a plurality of damping elements are received in each of the hollow chambers to support the frame relative to each of the rotary bodies in a form-fitting manner in a circumferential direction relative to the respective rotary body.

23. The screening machine of claim 12, wherein:
the at least one filler piece at least partially bridges at least one of the gap areas such that a remaining gap width of the gap area not bridged by the filler piece is at most 15 mm.

24. The screening machine of claim 12, wherein:
the at least one filler piece at least partially bridges at least one of the gap areas such that a remaining gap width of the gap area not bridged by the filler piece is at most 10 mm.
